(19) United States
(12) Patent Application Publication
(10) Pub. No.: US 2019/0332532 A1
(43) Pub. Date: Oct. 31, 2019

(54) PROCESSING MESSAGE

(71) Applicant: NEW H3C TECHNOLOGIES CO., LTD., Hangzhou (CN)

(72) Inventors: Shaoliang AN, Beijing (CN); Changzhong GE, Beijing (CN)

(21) Appl. No.: 16/475,040

(22) PCT Filed: Dec. 27, 2017
(86) PCT No.: PCT/CN2017/118842

§ 371 Date: Jun. 28, 2019

(30) Foreign Application Priority Data
Dec. 28, 2016 (CN) 201611236629.1

(51) Int. Cl. G06F 12/0806

(52) U.S. Cl. CPC G06F 12/0806; G06F 11/362

(57) ABSTRACT

A method and device for processing a message are provided. According to an example of the method, after an operation message is generated, it is determined whether a block cache matching the operation message exists in a cache pool, where the cache pool includes a plurality of block caches for caching different operation messages, respectively. When the matched block cache exists in the cache pool, a condition parameter in the block cache is updated. It is then determined whether the matched block cache satisfies a preset output condition according to the condition parameter in the block cache. If the block cache satisfies the preset output condition, the operation message in the block cache is output.

### CROSS REFERENCE TO RELATED APPLICATION

This application claims priority to Chinese Patent Application No. 201611236629.1 entitled “METHOD AND DEVICE FOR PROCESSING MESSAGE” filed on Dec. 28, 2016, the entire content of which is incorporated herein by reference.

### BACKGROUND

During debugging and running of a device, numerous operation messages will be generated by processes in the device and may be displayed on a display screen so as to be viewed by an administrator. Since the size of the display screen is limited, the oldest operation message that has been displayed will be overwritten when the total number of the generated operation messages exceeds the maximum number of messages that can be displayed on the display screen.

For example, assuming that the maximum number of messages that can be displayed on a display screen is M, the operation messages generated by the processes will be displayed on the display screen one by one. When the total number of the generated operation messages is M, the first to the M-th operation messages are displayed on the display screen. If an (M+1)-th operation message is generated subsequently, the first operation message will be overwritten so that the second to the (M+1)-th operation messages are displayed, and so on. Thus, the display screen always displays the latest M messages.

### BRIEF DESCRIPTION OF THE DRAWINGS

FIG. 1 illustrates a schematic structure diagram of a cache pool according to an example of the present disclosure.

FIG. 2 illustrates another schematic structure diagram of a cache pool according to an example of the present disclosure.

FIG. 3 illustrates a flow diagram of a method of processing a message based on the cache pool shown in FIG. 1 according to an example of the present disclosure.

FIG. 4 illustrates a flow diagram of a method of processing a message based on the cache pool shown in FIG. 2 according to an example of the present disclosure.

FIG. 5 illustrates a schematic structure diagram of a device for processing a message according to an example of the present disclosure.

FIG. 6 illustrates a schematic structure diagram of a device for processing a message according to another example of the present disclosure.

### DETAILED DESCRIPTION OF THE EMBODIMENTS

Example embodiments will be described in detail herein with the examples thereof represented in the drawings. When the following descriptions involve the drawings, like numerals in different drawings represent like or similar elements unless stated otherwise. The implementations described in the following example embodiments do not represent all implementations consistent with the present disclosure. On the contrary, they are examples of a device and a method described in detail in the appended claims that are consistent with some aspects of the present disclosure.

The terminology used in the present disclosure is for the purpose of describing a particular example only, and is not intended to be limiting of the present disclosure. The singular forms such as “a”, ‘said”, and “the” used in the present disclosure and the appended claims are also intended to include multiple, unless the context clearly indicates otherwise. It is also to be understood that the term “and/or” as used herein refers to any or all possible combinations that include one or more associated listed items.

It should be appreciated that although different information may be described using the terms such as first, second, third, etc. in the present disclosure, the information should not be limited to these terms. These terms are used only to distinguish the same type of information from each other. For example, the first information may also be referred to as the second information without departing from the scope of the present disclosure, and similarly, the second information may also be referred to as the first information. Depending on the context, the word “if” as used herein may be interpreted as “when” or “as” or “determining in response to”.

According to an example of the present disclosure, there is provided a method of processing a message and a device for processing a message to which the method is applied.

According to the method of processing a message, after an operation message is generated, a processor may determine whether a block cache matching the operation message exists in a cache pool, where the cache pool includes a plurality of block caches for caching different operation messages. If the matched block cache exists in the cache pool, the processor may update a condition parameter in the block cache. Then, the processor may determine whether the matched block cache satisfies a preset output condition according to the condition parameter in the matched block cache. If the block cache satisfies the preset output condition, the processor outputs an operation message in the block cache.

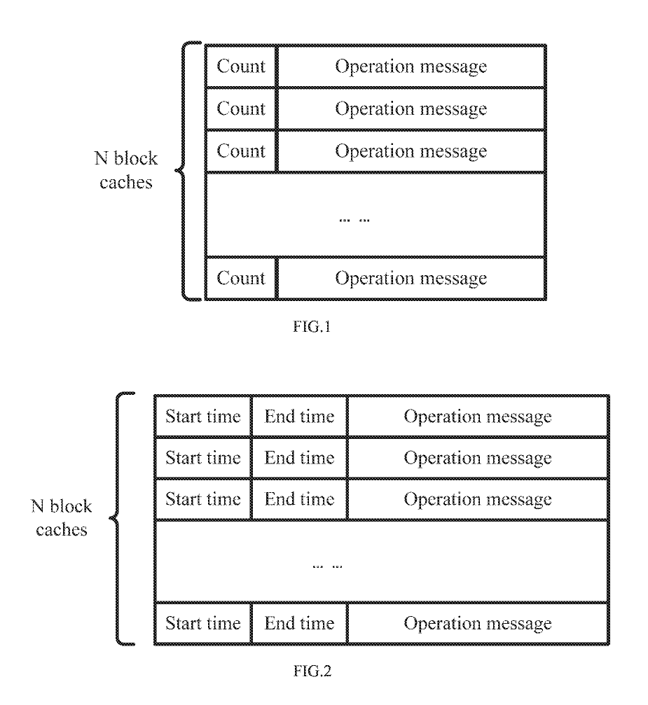

During debugging and running of a device, numerous operation messages may be generated by processes in the device. To process such operation messages, a cache space may be set up as a cache pool on the device. As shown in FIG. 1 or FIG. 2, the cache pool may be partitioned into N block caches for caching operation messages and parameters relating to the operation messages, where N is a positive integer which can be set according to actual requirements.

As shown in FIG. 1, each block cache in the cache pool may be configured to cache an operation message and a count corresponding to the operation message, where the initial value of the count may be set to 0, which indicates that the block cache is in an idle state.

For another example, as shown in FIG. 2, each block cache in the cache pool may be configured to cache an operation message, start time and end time corresponding to the operation message, where the start time is the time when the operation message is first generated and the end time is the time when the operation message is last generated.

Apparently, the block cache shown in FIG. 1 or FIG. 2 may also contain a status flag for indicating whether the block cache is idle, and the initial value of the status flag is set to Idle. In addition, the block cache structure as shown in FIG. 1 and the block cache structure as shown in FIG. 2 may also be combined so that a block cache may be used for caching a count, start time, end time, and an operation message.

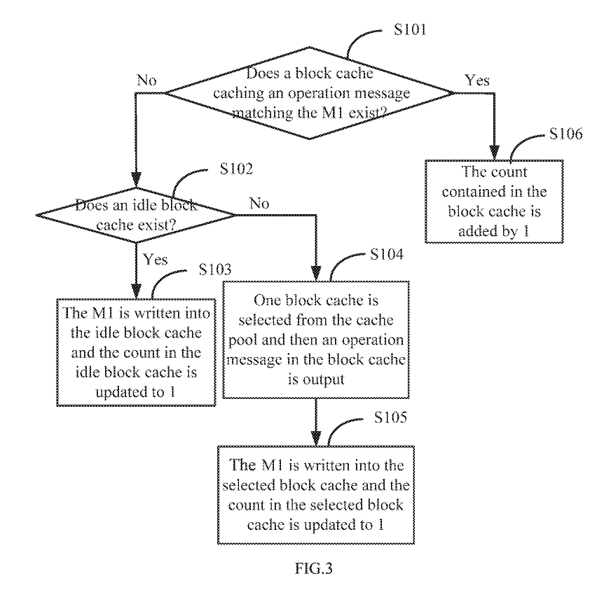

Thus, when the block caches in the cache pool are as shown in FIG. 1, a method of processing a message according to an example of the present disclosure may be as shown in FIG. 3, including the following blocks:

At block S101, after an operation message (denoted as M1, for the convenience of description) is generated, it may be determined whether a block cache, which caches an operation message matching the M1, exists in a cache pool. If no, block S102 is executed, and if yes, block S106 is executed.

The operation message matching the M1 may be the same operation message as the M1, and may also be an operation message that fuzzily matches the M1. Thus, at block S101, it may be determined whether a block cache, which caches an operation message matching the M1, exists in a cache pool according to the following method 1 or method 2.

Method 1: Exact Match Method

For each non-idle block cache in a cache pool, it may be determined whether an operation message in the block cache is the same as the M1. If yes, it is determined that the operation message in the block cache matches the M1, so that it is determined that a block cache, which caches an operation message matching the M1, exists in the cache pool, or otherwise, it is determined that no block cache, which caches the operation message matching the M1, exists in the cache pool.

Method 2: Fuzzy Match Method

For each non-idle block cache in a cache pool, it may be determined whether a code ID contained in the block cache is the same as an ID of a piece of code that generates the M1. If yes, it is determined that an operation message in the block cache fuzzily matches the M1, so that it is determined that a block cache, which caches the operation message matching the M1, exists in the cache pool. Or otherwise, it is determined that no block cache, which caches the operation message matching the M1, exists in the cache pool, where the code ID contained in the block cache is an ID of the code that generates the operation message in the block cache.

Apparently, in the above method 2, a block cache as shown in FIG. 1 is further required to contain a code ID which is the ID of the code that generates an operation message in the block cache. By using the method 2, the time for determination can be reduced and the efficiency of determination can be improved.

A program may be composed of one or more files, where each file contains one or more functions and code lines in each file are independently numbered. Therefore, the above code ID may specifically be composed of a line number of the code and the name of a function to which the code belongs, or composed of a line number of the code and the name of a file to which the code belongs.

At block S102, it may be determined whether an idle block cache exists in the cache pool. If yes, block S103 is executed, or otherwise, block S104 is executed.

At block S103, the M1 may be written into the idle block cache and the count contained in the idle block cache may be updated to 1, and then the flow is terminated. If the block cache contains a status flag, it is further required to update the status flag to Non-idle at block S103.

At block S104, one block cache may be selected from the cache pool and then an operation message in the block cache may be output, and then block S105 is executed.

At block S104, one block cache may be selected from the cache pool according to a particular selection rule. For example, one block cache containing a maximum count may be selected, or one block cache may be randomly selected, which will not be limited herein.

At block S105, the M1 may be written into the selected block cache and the count contained in the selected block cache may be updated to 1, and thus the flow is terminated.

After block S105 is executed, the operation message cached in the block cache may be updated to the M1.

At block S106, the count contained in the block cache which caches the operation message matching the M1 may be added by 1, and then the flow is quitted.

In addition, it is also required to determine whether the block cache satisfies a preset output condition according to the count in the block cache. The preset output condition may be that the count contained in the block cache reaches a preset threshold. If the preset output condition is satisfied, the operation message in the block cache may be output. By setting the above preset output condition, the operation message of which the accumulated number reaches the preset threshold may be output.

In an example, after block S106 is executed, it may be determined, for the block cache of which the count is added by 1, whether the count contained in the block cache reaches the preset threshold. If yes, the operation message in the block cache may be output and the count may be updated to 0. If the block cache contains a status flag, the status flag may also be updated to Idle. For another example, it may also be determined whether the count contained in each non-idle block cache in the cache pool reaches the preset threshold when a preset time period expires. If yes, the operation message in the block cache may be output and the count may be updated to 0. If the block cache contains a status flag, the status flag may also be updated to Idle.

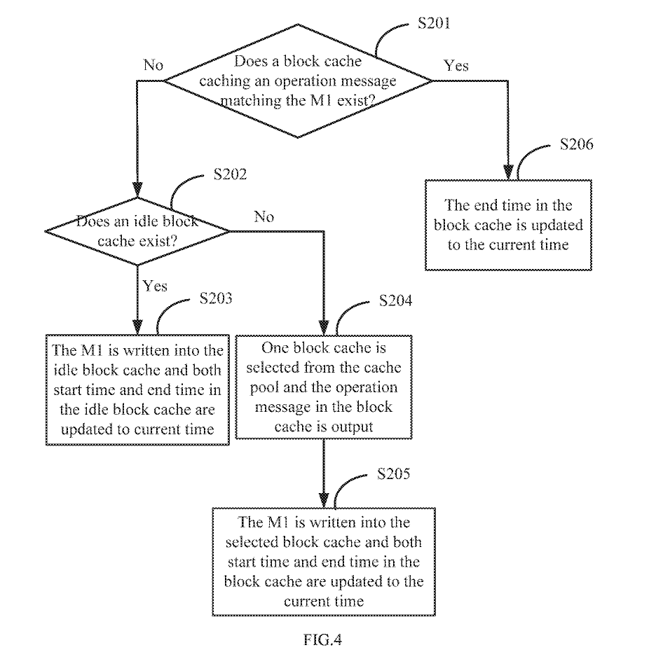

Besides, when the block caches in the cache pool are as shown in FIG. 2, a method of processing a message according to an example of the present disclosure may be as shown in FIG. 4, including the following blocks.

At block S201, after the M1 is generated, it may be determined whether a block cache, which caches an operation message matching the M1, exists in the cache pool. If no, block 202 is executed, and if yes, block S206 is executed.

At block S202, it may be determined whether an idle block cache exists in the cache pool. If yes, block S203 is executed, or otherwise, block S204 is executed.

At block S203, the M1 may be written into the idle block cache and both start time and end time in the idle block cache may be updated to current time, and thus the flow is terminated. If the block cache contains a status flag, it may be further required to update the status flag to Non-idle at block S203.

At block S204, one block cache may be selected from the cache pool and the operation message in the block cache may be output, and then block S205 may be executed.

At block S204, one block cache may be selected from the cache pool according to a particular selection rule. For example, one block cache containing the earliest end time may be selected, or one block cache may be randomly selected, which will not be limited herein.

At block S205, the M1 may be written into the selected block cache and both start time and end time in the block cache may be updated to the current time, and thus the flow is terminated.

After block S205 is executed, the operation message cached in the selected block cache may be updated to the M1.

At block S206, the end time in the block cache which caches the operation message matching the M1 may be updated to the current time, and thus the flow may be terminated.

In addition, it may be also required to determine whether the block cache satisfies a preset output condition according to the count in the block cache. The preset output condition may be that a difference between current time and end time in the block cache is greater than a preset time threshold. If the preset output condition is satisfied, the operation message in the block cache may be output. By setting the above preset output condition, the operation message in the block cache may be output which satisfies the condition that a difference between the current time and the end time when the operation message is last generated reaches the preset time threshold.

For example, after block S206 is executed, it may be determined, for the block cache in which the end time is updated, whether a difference between the current time and the end time in the block cache is greater than the preset time threshold. If yes, the operation message in the block cache may be output. If the block cache contains a status flag, the status flag may also be updated to Idle. For another example, for each non-idle block cache in the cache pool, it may also be determined whether a difference between the current time and the end time in the block cache is greater than the preset time threshold when a preset time period expires. If yes, the operation message in the block cache may be output. If the block cache contains a status flag, the status flag may also be updated to Idle.

In the above method as shown in FIG. 3 or FIG. 4, when an operation message in the block cache is output, parameters relating to the operation message, such as the count or the start time and the end time, may also be output together. In practical implementation, the operation message and the relevant parameters thereof may be directly output to a display screen for display, and may also be stored in a queue or a log file and then displayed when required. An administrator may view such relevant parameters while viewing the operation message and can conduct analysis and processing work such as fault location with such relevant parameters.

Additionally, in another example, when the block cache structure as shown in FIG. 1 is combined with the block cache structure as shown in FIG. 2, so that a block cache is used for caching a count, start time, end time and a operation message, then the method of processing a message may be a combination of the method as shown in FIG. 3 and the method as shown in FIG. 4, which will not be redundantly described herein. For example, when adding the count in a block cache by 1, it may also be required to update the end time to the current time. When the count in the block cache is updated to 1, it may also be required to update both the start time and the end time to the current time.

In the above method according to one or more examples of the present disclosure, operation messages may be merged. When the operation message obtained by the merging satisfies a preset output condition, the operation message may be output. Thus, message redundancy can be reduced without reducing the message content. Moreover, when the output operation message is displayed subsequently, more different operation messages can be displayed on the display screen, improving the displaying efficiency.

Corresponding to the aforesaid examples of the method of processing a message, the present disclosure also provides an example of a device for processing a message.

An example of a device for processing a message 50 in the present disclosure may be applied to a device capable of generating an operation message. The device example may be implemented by software, and may also be implemented by hardware or a combination of software and hardware.

FIG. 5 illustrates a schematic structure diagram of a device for processing a message according to an example of the present disclosure. The device for processing a message 50 includes the following units: a determining unit 501, an updating unit 502, and an outputting unit 503.

The determining unit 501 is configured to determine whether a first block cache matching a first operation message exists in a cache pool after the first operation message is generated, where the cache pool includes a plurality of block caches for caching different operation messages, respectively and the determining unit 501 may also be configured to determine whether the first block cache satisfies a preset output condition according to a condition parameter in the first block cache.

The updating unit 502 is configured to update a condition parameter in the first block cache if the determining unit 501 determines that the first block cache exists in the cache pool.

The outputting unit 503 is configured to output an operation message in the first block cache if the determining unit 501 determines that the first block cache satisfies the preset output condition.

In an example, the updating unit 502 is configured to update the condition parameter in the first block cache in the following manner: adding a count in the first block cache by 1, where the preset output condition is that the count in the first block cache reaches a preset threshold.

When determining that the first block cache does not exist in the cache pool, the determining unit 501 may determine whether an idle second block cache exists in the cache pool. If the determining unit 501 determines that no idle second block cache exists in the cache pool, the outputting unit 503 may select a third block cache satisfying the preset output condition from the cache pool. Then, the outputting unit 503 outputs second operation message in the third block cache.

The updating unit 502 is also configured to write the generated first operation message into the second block cache and update a count in the second block cache to 1 if the determining unit 501 determines that the first block cache does not exist in the cache pool but the idle second block cache exists in the cache pool; and also the updating unit 502 may be configured to write the generated first operation message into the third block cache and update a count in the third block cache to 1 after the outputting unit 503 outputs the second operation message in the selected third block cache.

In another example, the updating unit 502 is specifically configured to update the condition parameter in the first block cache in the following manner: updating end time in the first block cache to current time, wherein the above preset output condition is that a difference between the current time and the end time in the block cache is greater than a preset threshold.

In another example, the outputting unit 503 is also configured to select a third block cache from the cache pool and output the second operation message in the third block cache if the determining unit 501 determines that the first block cache and the idle second block cache do not exist in the cache pool.

The updating unit 502 is also configured to write the generated first operation message into the second block cache and update the start time and the end time in the second block cache to the current time if the determining unit 501 determines that the first block cache does not exist in the cache pool but the idle second block cache exists in the message buffer pool; also the updating unit 502 may be configured to write the generated first operation message into the third block cache and update the start time and the end time in the third block cache to the current time after the outputting unit 503 outputs the second operation message in the selected third block cache.

Details of the implementation process of the functions and effects of different units in the above-described device may be seen from the implementation process of corresponding blocks in the above-described method, which will not be redundantly described herein.

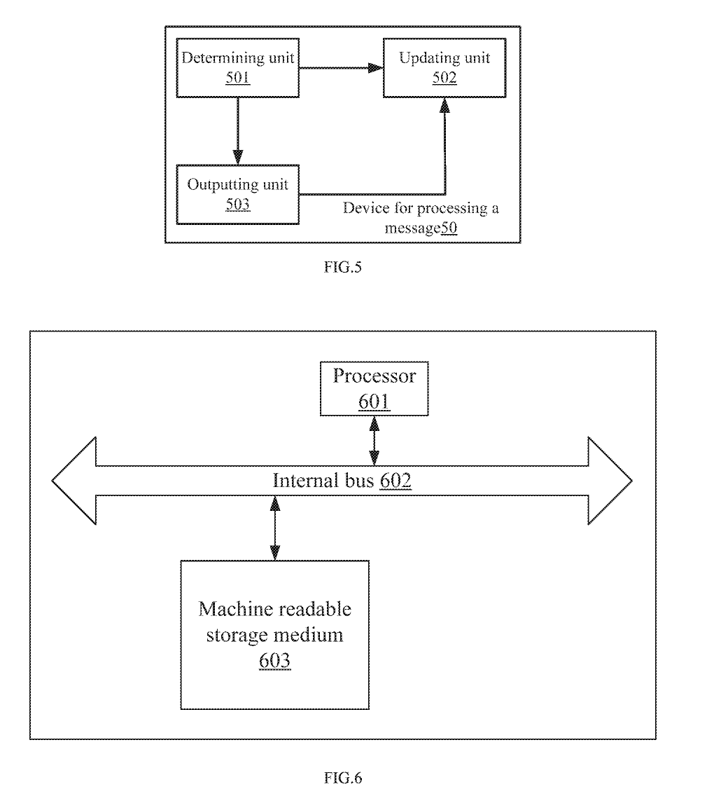

FIG. 6 illustrates a schematic structure diagram of a device for processing a message according to another example of the present disclosure. The device for processing a message includes: a processor 601 and a machine-readable storage medium 602 that stores machine-executable instructions. The processor 601 may communicate with the machine-readable storage medium 602 via a system bus 603. The processor 601 may execute the above-described method of processing a message by reading and executing the machine-executable instructions on the machine-readable storage medium 602.

The machine-readable storage medium 602 described herein may be any electronic, magnetic, optical or other physical storage device, and may contain or store information, such as executable instructions, data and the like. For example, the machine-readable storage medium may be a Random Access Memory (RAM), a volatile memory, a nonvolatile memory, a flash memory, a storage drive (e.g., hard disk drive), a solid state disk, any type of storage disk (e.g., optical disk, Digital Video Disk (DVD)), or a similar storage medium, or a combination thereof.

The machine-readable storage medium 602 is used to store program instructions run by the determining unit 501, program instructions run by the updating unit 502, and program instructions run by the outputting unit 503.

The processor 601 is used to execute the program instructions run by the determining unit 501, the program instructions run by the updating unit 502, and the program instructions run by the outputting unit 503. The processor 601 may implement the method of processing a message as described above by executing the program instructions run by each of the above units.

In an example, the processor 601 is caused by reading and executing the machine-executable instructions in the machine-readable storage medium 602 to:
determine whether a first block cache matching a first operation message exists in a cache pool after the first operation message is generated, where the cache pool includes a plurality of block caches for caching different operation messages, respectively;
update a condition parameter in the first block cache if the first block cache exists in the cache pool;
determine whether the first block cache satisfies a preset output condition according to the condition parameter in the first block cache; and
output the operation message in the first block cache if the first block cache satisfies the preset output condition.

In an example, when updating the condition parameter in the first block cache, the processor 601 is also caused by the machine-executable instructions to:
add a count in the first block cache by 1, where the preset output condition is that the count in the block cache reaches a preset threshold.

In an example, when the first block cache does not exist in the cache pool, the processor 601 is also caused by the machine-executable instructions to:
determine whether an idle second block cache exists in the cache pool; and
when the idle second block cache exists in the cache pool,
   write the first operation message into the second block cache, and
   update the count in the second block cache to 1.

In an example, when the second block cache does not exist in the cache pool, the processor 601 is also caused by the machine-executable instructions to:
select a third block cache satisfying the preset output condition from the cache pool;
output second operation message in the third block cache;
write the first operation message into the third block cache; and
update the count in the third block cache to 1.

In an example, when updating the condition parameter in the first block cache, the processor is also caused by the machine-executable instructions to:
update end time in the first block cache to current time, where the preset output condition is that a difference between the current time and the end time in the first block cache is greater than a preset threshold.

In an example, when the first block cache does not exist in the cache pool, the processor is also caused by the machine-executable instructions to:
determine whether an idle second block cache exists in the cache pool; and
when the second block cache exists in the cache pool,
   write the first operation message into the second block cache, and
   update the start time and the end time in the second block cache to the current time.

In an example, when the second block cache does not exist in the cache pool, the processor is also caused by the machine-executable instructions to:
select a third block cache from the cache pool;
output second operation message in the third block cache;
write the first operation message into the third block cache; and
update the start time and the end time in the third block cache to the current time.

Since the device examples substantially correspond to the method examples, a reference may be made to part of the descriptions of the method examples for the related part. The device examples described above are merely illustrative, where the units described as separate members may be or not be physically separated, and the members displayed as units may be or not be physical units, i.e., may be located in one place, or may be distributed to a plurality of network units. Part or all of the modules may be selected according to actual requirements to implement the objectives of the solutions in the examples. Those of ordinary skill in the art may understand and carry out them without creative work.

It needs to be noted that the relational terms such as “first” and “second” used herein are merely intended to distinguish one entity or operation from another entity or operation rather than to require or imply any such actual relation or order existing between these entities or operations. Also, the term “including”, “containing” or any variation thereof is intended to encompass non-exclusive inclusion, so that a process, method, article or device including a series of elements includes not only those elements but also other elements not listed explicitly or those elements inherent to such a process, method, article or device. Without more limitations, an element defined by the statement “including a . . . ” shall not be precluded to include additional same elements present in a process, method, article or device including the elements.

The above are detailed descriptions of a method and a device provided according to the examples of the present disclosure. Specific examples are used herein to set forth the principles and the implementing methods of the present disclosure, and the descriptions of the above examples are only meant to help understanding of the method and the core idea of the present disclosure. Meanwhile, those of ordinary skill in the art may make alterations to the specific examples and the scope of application in accordance with the idea of the present disclosure. In conclusion, the contents of the present specification shall not be interpreted as limiting to the present disclosure.

1. A method of processing a message, comprising:
determining, by a processor, whether a first block cache matching a first operation message exists in a cache pool after the first operation message is generated, wherein the cache pool comprises a plurality of block caches for caching different operation messages, respectively;
updating, by the processor, a condition parameter in the first block cache when the first block cache exists in the cache pool;
determining, by the processor, whether the first block cache satisfies a preset output condition according to the condition parameter in the first block cache; and
outputting, by the processor, an operation message in the first block cache when the first block cache satisfies the preset output condition.

2. The method according to claim 1, wherein,
updating the condition parameter in the first block cache comprises:
adding, by the processor, a count in the first block cache by 1; and
the preset output condition is that the count in the first block cache reaches a preset threshold.

3. The method according to claim 2, further comprising:
determining, by the processor, whether an idle second block cache exists in the cache pool when the first block cache does not exist in the cache pool; and
when the second block cache exists in the cache pool,
writing, by the processor, the first operation message into the second block cache, and
updating, by the processor, a count in the second block cache to 1.

4. The method according to claim 3, further comprising:
selecting, by the processor, a third block cache satisfying the preset output condition from the cache pool when the second block cache does not exist in the cache pool;
outputting, by the processor, second operation message in the third block cache;
writing, by the processor, the first operation message into the third block cache; and
updating, by the processor, the count in the third block cache to 1.

5. The method according to claim 1, wherein,
updating the condition parameter in the first block cache comprises:
updating, by the processor, end time in the first block cache to current time; and
the preset output condition is that a difference between the current time and the end time in the first block cache is greater than a preset threshold.

6. The method according to claim 5, further comprising:
determining, by the processor, whether an idle second block cache exists in the cache pool when the first block cache does not exist in the cache pool; and
when the second block cache exists in the cache pool,
writing, by the processor, the first operation message into the second block cache, and
updating, by the processor, start time and the end time in the second block cache to the current time.

7. The method according to claim 6, further comprising:
selecting, by the processor, a third block cache from the cache pool when the second block cache does not exist in the cache pool;
outputting, by the processor, second operation message in the third block cache;
writing, by the processor, the first operation message into the third block cache; and
updating, by the processor, the start time and the end time in the third block cache to the current time.

8. A device for processing a message, comprising:
a processor; and
a non-transitory storage medium storing machine-executable instructions, wherein by reading and executing the machine-executable instructions, the processor is caused to:
determine whether a first block cache matching a first operation message exists in a cache pool after the first operation message is generated, wherein the cache pool comprises a plurality of block caches for caching different operation messages, respectively;
update a condition parameter in the first block cache when the first block cache exists in the cache pool;
determine whether the first block cache satisfies a preset output condition according to the condition parameter in the first block cache; and
output an operation message in the first block cache when the first block cache satisfies the preset output condition.

9. The device according to claim 8, wherein,
when updating the condition parameter in the first block cache, the processor is further caused by the machine-executable instructions to:
add a count in the first block cache by 1; and
the preset output condition is that the count in the first block cache reaches a preset threshold.

10. The device according to claim 9, wherein when the first block cache does not exist in the cache pool, the processor is further caused by the machine-executable instructions to:
determine whether an idle second block cache exists in the cache pool; and
when the second block cache exists in the cache pool,
write the first operation message into the second block cache, and
update a count in the second block cache to 1.

11. The device according to claim 10, wherein when the second block cache does not exist in the cache pool, the processor is further caused by the machine-executable instructions to:
select a third block cache satisfying the preset output condition from the cache pool;
output second operation message in the third block cache;
write the first operation message into the third block cache; and
update the count in the third block cache to 1.

12. The device according to claim 8, wherein when updating the condition parameter in the first block cache, the processor is further caused by the machine-executable instructions to:
update end time in the first block cache to current time; and
the preset output condition is that a difference between the current time and the end time in the first block cache is greater than a preset threshold.

13. The device according to claim 12, wherein when the first block cache does not exist in the cache pool, the processor is further caused by the machine-executable instructions to:
determine whether an idle second block cache exists in the cache pool; and
when the second block cache exists in the cache pool,
write the first operation message into the second block cache, and
update start time and the end time in the second block cache to the current time.

14. The device according to claim 13, wherein when the second block cache does not exist in the cache pool, the processor is further caused by the machine-executable instructions to:
select a third block cache from the cache pool;
output second operation message in the third block cache;
write the first operation message into the third block cache; and
update the start time and the end time in the third block cache to the current time.
